(19) United States
(12) Patent Application Publication
(10) Pub. No.: US 2026/0030308 A1
(43) Pub. Date: Jan. 29, 2026

(54) SYSTEM AND A METHOD FOR DETERMINING RELEVANT ENTITIES AND PRODUCTS USING LLM MODEL

(71) Applicant: XLSCOUT XLPAT INC, Wilmington, DE (US)

(72) Inventors: Manish Verma, Wilmington, DE (US); Punit Talwar, Wilmington, DE (US); Jitin Talwar, Wilmington, DE (US)

(21) Appl. No.: 19/279,179

(22) Filed: Jul. 24, 2025

Related U.S. Application Data
(60) Provisional application No. 63/675,063, filed on Jul. 24, 2024.

(51) Int. Cl. G06F 16/9538; G06F 16/951; G06F 40/30

(52) U.S. Cl. CPC G06F 16/9538; G06F 16/951; G06F 40/30

(57) ABSTRACT

The present disclosure relates to a system and a method for determining relevant entities and products using an LLM model. A patent information extraction unit extracts patent related information. A large language model (LLM) unit analyzes the extracted claims for identifying top companies, startups, and products, forming a first list. A background collection module employs the LLM units along with advanced searching unit to generate a second list of relevant entities and products. A result combiner unit generates a list of relevant entities and products. A web mining unit search for relevant hyperlinks disclosing features of the identified products. A RAG module embeds background text extracted from identified hyperlinks. A claim chart module generates a claim chart table for each of the identified products. A ranking module ranks the patent via a weightage-based score and a report generation unit prepares a summarized report comprising an image-report and a textual-report.

### CROSS-REFERENCE TO RELATED APPLICATION

This application claims the benefit of U.S. Provisional Application Ser. No. 63/675,063, filed on Jul. 24, 2024, entitled “SYSTEM AND METHOD FOR DETERMINING RELEVANT ENTITIES AND PRODUCTS USING LLM MODEL,” commonly assigned with this application and incorporated herein by reference in its entirety.

### FIELD OF THE DISCLOSURE

The present disclosure relates generally to a system and a method for analysis of patent data and more particularly to a system and a method for determining relevant entities and products using LLM model based on comprehensive analysis of patent data.

### BACKGROUND

In today's dynamic and competitive business landscape, the ability to efficiently evaluate market and identify relevant entities and products is essential to maintain a competitive edge and make informed decisions. However, traditional methods of analysis often involve manual processes that are time-consuming and prone to errors. Several systems have been developed to automate the process of market analysis and identification of relevant entities and products. However, these prior art systems have several limitations, such as relying solely on training datasets, and may not provide accurate or comprehensive results, ultimately impacting the effectiveness of business strategies.

Patent data plays a crucial role in understanding recent market strategies and commercial trends across various industry. The patent data is a techno-legal document, thereby serves as an authentic source of information about a product and its rightful owner. This information is significantly valuable in the case of franchising, licensing, and commercial exploitation of any product. Equally important is the ability, to identify potential licensees and detect possible infringements. For all these purposes detailed analysis of patent document is to be performed, however it demands a lot of manual work and time.

Existing technologies used for patent analysis in the art faced challenges in effectively monitoring infringement behaviors, analyzing highly specialized documents, and providing high-quality data analysis. Further, the existing systems have many drawbacks, such as time-consuming manual processes, inaccurate results, and difficulties in standardizing data maintenance. In view of the limitations of the prior art systems, there is a need to have an improved systems and method that can efficiently perform analysis of the patent data and accurately identify the relevant entities and products associated with a particular technology.

Moreover, there is an urgent requirement to map claim elements of patent documents and generate respective claim chart tables, thereby providing a comprehensive contextual and visual mapping of the claim elements to the corresponding products. Particularly, analyzing visual product information, such as images depicting specific product features, significantly enhances the accuracy and comprehensiveness of the claim chart mapping. However, manually scraping relevant product images and associating these images precisely with the claim elements is an intricate, time-consuming, and labor-intensive process. It requires considerable manual effort to systematically locate, identify, and extract visual product data from disparate sources, followed by meticulous comparison and mapping of visual data against textual claim elements. Currently, there is no automated or semi-automated solution available in the prior art capable of efficiently performing visual data extraction and claim-element-to-product image association.

The present disclosure solves the above-mentioned problems by addressing these limitations of prior art systems, providing an automated system and method for enhanced analysis of patent data. This is achieved by leveraging a pre-trained large language model (LLM) module and an advanced internet search module capable of not only extracting and analyzing textual information but also effectively scraping, processing, and mapping the relevant product images, thereby significantly reducing analysis time and improving the mapping accuracy.

### SUMMARY

A system for determining relevant entities and products is provided. The system comprising a patent information extraction unit, a plurality of large language model (LLM) units, an advanced searching unit, a result combiner unit, a web mining unit, a retrieval augmented generation (RAG) module, a claim chart generator module, a ranking module, and a report generation unit. Further, the patent information extraction unit is configured to extract patent information associated with a received patent number of a patent from one or more patent databases. The plurality of LLM units are configured to process and analyze extracted claims to provide distinct claim elements. The advanced searching unit is configured to perform an internet-based search to identify relevant entities and products based on the distinct claim elements. The result combiner unit is configured to generate a list of relevant entities and products. The web mining unit is configured to search for relevant hyperlinks disclosing features associated with the claim elements of the relevant entities and products. The RAG module is configured to process and embed background text extracted from the relevant hyperlinks of the identified entities and products. The claim chart generator module is configured to generate claim chart tables for each of the identified entities and products against the distinct claim elements. The ranking module is configured to rank the patent via applying a quantitative weightage-based score and calculating a mapping percentage to generate a prioritized, sorted list of patents and products, the weightage-based score is obtained via overlapping features of the patent with the identified entities and products. The report generation unit is configured to generate a summarized report for the identified entities and products, thereby providing comprehensive details about each of the entities and products against the specific claim elements of the received patent. The summarized report comprises an image report and a textual report.

In an embodiment of the present disclosure, the background collection module comprises a first unit, the advanced searching unit, and a third unit. The first unit is configured to process and analyze the extracted claims. The advanced searching unit is configured to conduct targeted internet searches based on the optimized prompts to gather the relevant hyperlinks. Further, the third LLM unit configured to filter and refine the retrieved hyperlinks based on predefined relevancy parameters.

In an embodiment of the present disclosure, the RAG module comprises an embedding unit and a vector database unit. The embedding unit is configured to process and embed the background text extracted from the relevant hyperlinks of the identified entities and products. Further, the vector database unit is configured to create a vector database based on contextual compression indexing techniques for storing and retrieving the background text.

In an embodiment of the present disclosure, a scheduler unit is configured to initiate predefined alert notifications based on user-defined preferences for informing users regarding completion of analysis and generation of summarized reports.

A method for determining relevant entities and products is provided. The method comprising extracting using a patent information extraction unit, patent information associated with a received patent number of a patent from one or more databases. The method further includes processing and analyzing, extracted claims using a plurality of large language model units to provide distinct claim elements. The method then comprises performing using an advanced searching unit, an internet-based search to identify relevant entities and products based on the distinct claim elements. Further, the method comprises generating using a result combiner unit, a list of the relevant entities and products. The method also includes searching, using a web mining unit, for relevant hyperlinks disclosing features associated with the claim elements of the relevant entities and products. Furthermore, the method comprises processing and embedding, using a retrieval augmented generation (RAG) module, a background text extracted from the relevant hyperlinks of the identified entities and products. Moreover, the method includes generating, using a claim chart generator module, a claim chart table for each of the identified entities and products against the distinct claim elements. The method comprises ranking, using a ranking module, the patent via applying a quantitative weightage-based score and calculating a mapping percentage to generate a prioritized sorted list of patents and products. The weightage-based score is obtained via overlapping features of the patent with the identified entities and products. Additionally, the method includes generating a summarized report, using a report generation unit, for the identified entities and products, providing comprehensive details about each of the entities and products against the specific claim elements of the received patent. The summarized report comprises an image-report and a textual report.

In an embodiment of the present disclosure, the method comprises a background collection module for performing the internet-based search comprising processing and analyzing the extracted claims using a first LLM unit. The method further comprises conducting by the advanced searching unit, targeted internet searches based on the optimized prompts to gather the relevant hyperlinks. Furthermore, the method includes filtering and refining the retrieved hyperlinks based on predefined relevancy parameters using a third LLM unit.

In an embodiment of the present disclosure, the method step of processing and embedding the background text by the RAG module comprises processing and embedding, by an embedding unit, the background text extracted from the relevant hyperlinks of the identified entities and products. The method step further comprises creating a vector database, using a vector database unit, based on contextual compression indexing techniques for storing and retrieving the background text.

In an embodiment of the present disclosure, the method further comprising initiating predefined alert notifications, by a scheduler unit, based on user-defined preferences for informing users regarding completion of analysis and generation of summarized reports.

### BRIEF DESCRIPTION

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

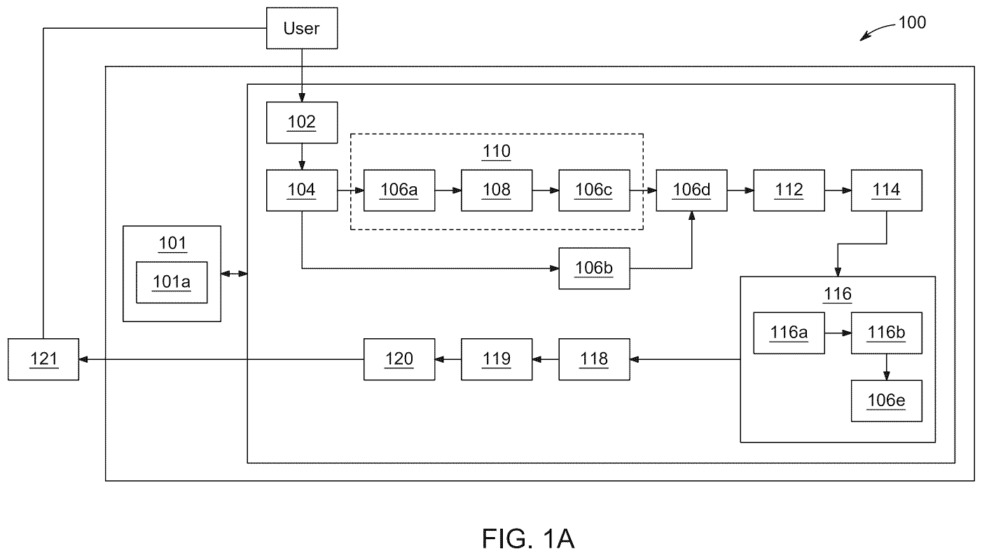

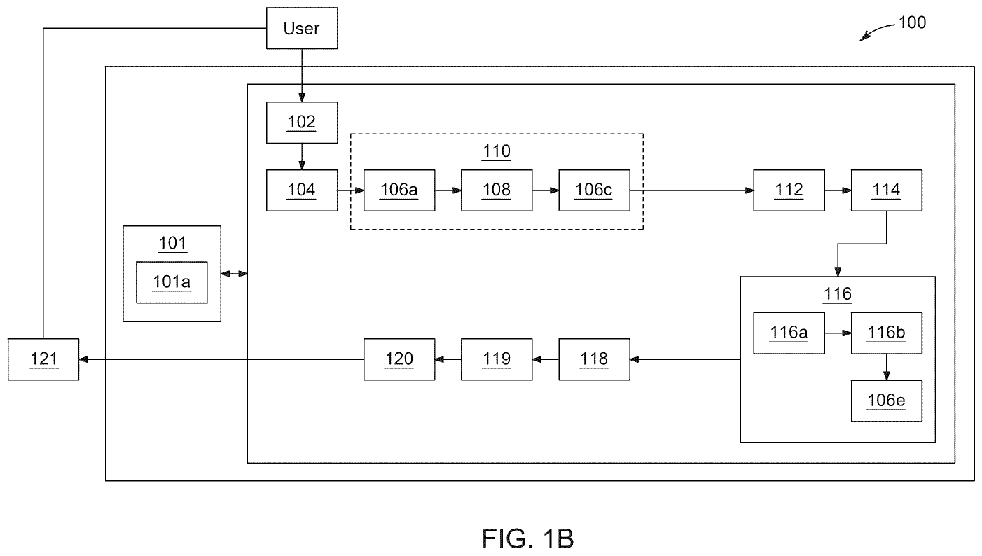

FIG. 1a illustrates an exemplary block diagram of a system for determining relevant entities and products using LLM model in accordance with the present disclosure;

FIG. 1b illustrates another exemplary block diagram of the system for determining relevant entities and products using LLM model in accordance with the present disclosure;

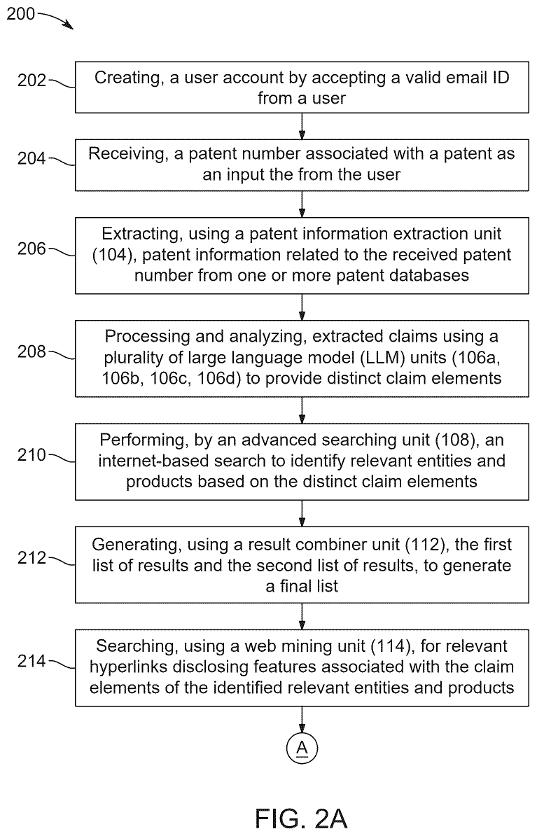

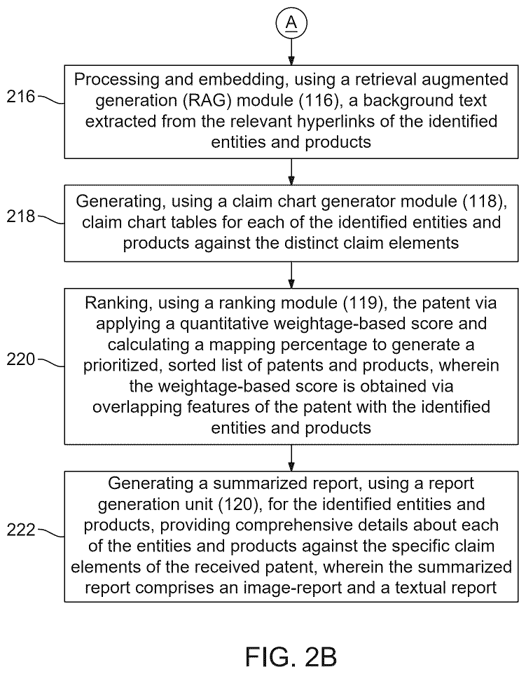

FIG. 2a and FIG. 2b illustrate an exemplary flowchart for a method for determining relevant entities and products using LLM model in accordance with the present disclosure;

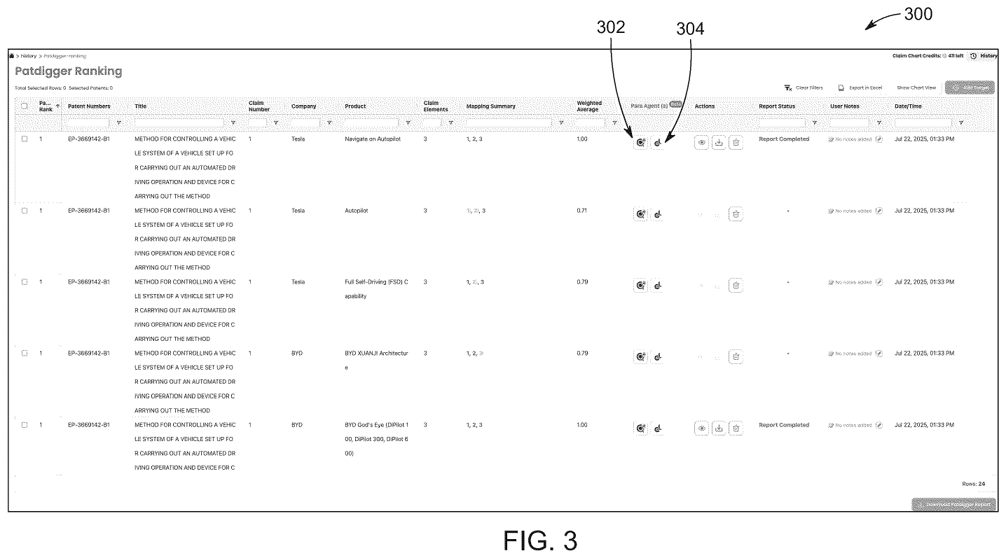

FIG. 3 illustrates an exemplary dashboard interface provided by a ranking module in accordance with the present disclosure;

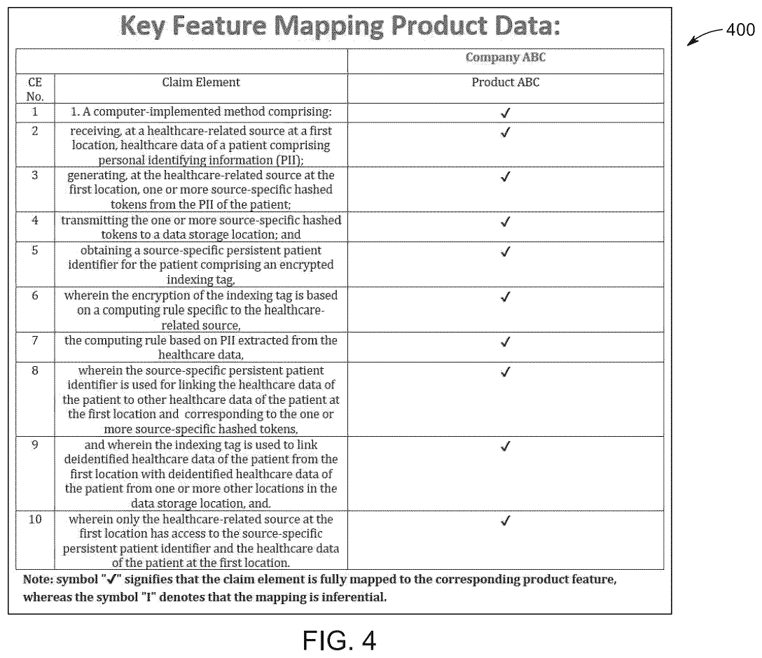

FIG. 4 illustrates an exemplary user interface displaying a summarized report generated by a report generation module including potential target companies and product mapping in accordance with the present disclosure; and

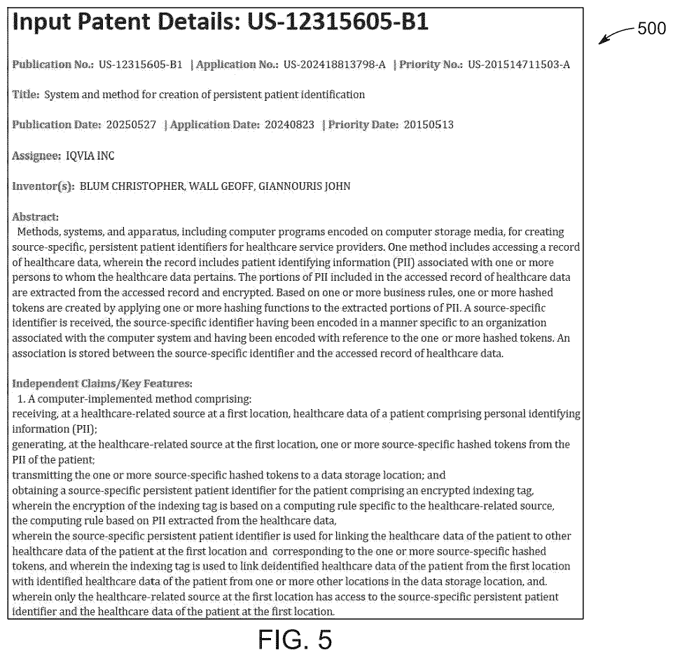

FIG. 5 illustrates another exemplary user interface displaying extracted patent information for a patent, generated by a patent information extraction unit via enhanced analysis of patent data using LLM model in accordance with the present disclosure.

### LIST OF REFERENCE NUMERALS

100—system
101—server
101a—repository
102—input unit
104—patent information extraction unit
106a—first large language model (LLM) unit
106b—second LLM unit
106c—third LLM unit
106d—fourth LLM unit
106e—fifth LLM unit
108—advanced searching unit
110—background collection module
112—result combiner unit
114—web mining unit
116—retrieval augmented generation (RAG) module
116a—embedding unit
116b—vector database unit
118—claim chart generator module
119—ranking module
120—report generation unit
121—scheduler unit
200—method
300—dashboard
302—first para-agent
304—second para-agent
400—summarized report
500—patent information

### DETAILED DESCRIPTION

Embodiments of the present disclosure are best understood by reference to the figures and description set forth herein. All the aspects of the embodiments described herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit and scope thereof, and the embodiments herein include all such modifications.

As used herein, the term ‘exemplary’ or ‘illustrative’ means ‘serving as an example, instance, or illustration.’ Any implementation described herein as exemplary or illustrative is not necessarily to be construed as advantageous and/or preferred over other embodiments.

Unless the context requires otherwise, throughout the description and the claims, the word ‘comprise’ and variations thereof, such as ‘comprises’ and ‘comprising’ are to be construed in an open, inclusive sense, i.e., as ‘including, but not limited to.

Aspects of the present invention are best understood by reference to the description set forth herein. All the aspects described herein will be better appreciated and understood when considered in conjunction with the following descriptions. It should be understood, however, that the following descriptions, while indicating preferred aspects and numerous specific details thereof, are given by way of illustration only and should not be treated as limitations. Changes and modifications may be made within the scope herein without departing from the spirit and scope thereof, and the present disclosure herein includes all such modifications.

This disclosure generally relates, inter alia, to methods, apparatuses, systems, and devices implemented as tools for patent information extraction and analysis, aimed at identifying leading companies, startups, and products. It further provides comprehensive contextual and visual mapping of claim elements to their corresponding products.

A plurality of pre-trained LLM units 106a-106e terms, as used herein, are a series of trained deep-learning models that understand seeded language and autonomously generate text in a manner similar to humans. The LLM units acquire the ability to recognize patterns, structures, and context within the language by implementing deep learning concepts and learning from a vast amount of diverse and extensive training data, such as patent documents, research papers, product descriptions, product images, and other relevant texts in the domain of interest. This enables them to perform tasks such as text summarization, consolidation, and analysis of extracted claims for identifying top companies, startups, and products, as well as searching for relevant entities and products and generating insightful reports.

The LLM units can capture long-range dependencies between words, enabling them to understand context and generate coherent text sequentially based on previously generated tokens. Additionally, the LLM units described herein employ advanced reasoning capabilities by utilizing customized thinking tokens, facilitating deeper and more precise contextual analysis. Furthermore, these LLM units are multimodal, capable of processing and analyzing both textual and visual data, as well as effectively interpreting the relationships between text and images.

The present disclosure provides a system 100 and a method 200 for determining relevant entities and products using an LLM model. The disclosure addresses the problems and limitations of traditional methods and prior art systems by leveraging advanced artificial intelligence techniques and modules, including a plurality of robust large language model (LLM) units 106a-106e, an advanced searching unit 108, a result combiner unit 112, a web mining unit 114, and a retrieval augmented generation (RAG) module 116, to accurately identify industry-leading entities and products, as well as to map claim elements for comprehensive contextual analysis.

FIG. 1a illustrates an exemplary block diagram of the system 100 for determining relevant entities and products using the LLM model in accordance with the present disclosure. The system 100 comprises an input unit 102, a patent information extraction unit 104, a plurality of large language model (LLM) units 106a-106e, advanced searching unit 108, a background collection module 110, a result combiner unit 112, a web mining unit 114, a retrieval augmented generation (RAG) module 116, a claim chart generator module 118, a ranking module 119, a report generation unit 120, and a scheduler unit 121. The plurality of LLM units comprise a first LLM unit 106a, a second LLM unit 106b, a third LLM unit 106c, a fourth LLM unit 106d, and a fifth LLM unit 106e.

In an embodiment of the present disclosure, the input unit 102 is configured to receive user input corresponding to a number associated with a patent. The number inputted by the user can be a publication number, an application number, or a granted patent number. The input unit 102 is to be integrated with a user interface or graphical user interface, allowing users to manually enter the relevant patent identifiers and initiate the analysis process.

In another embodiment of the present disclosure, the input unit 102 is configured to receive a plurality of numbers associated with the plurality of patents. In some examples, the plurality of numbers may comprise but not limited to, a publication number, an application number, or a granted patent number. The system 100 is configured to determine the relevant entities and products using the LLM model for the plurality of patents by receiving the corresponding numbers through the input unit 102 and initiate the analysis process sequentially for each of the plurality of patents.

Further, the patent information extraction unit 104 is configured to extract patent information 500 (as shown in FIG. 5), associated with the received patent number from one or more patent databases. The extracted information includes patent information 500 such as title, abstract, claims, detailed description, inventors, assignee, and priority date. The patent information extraction unit 104 is coupled to a backend server 101, which is selected from the group comprising of cloud servers, locally managed servers, or third-party services or combinations thereof. Further, the system 100 is configured to allow the user to select one or more extracted claims for further processing in the system 100. Thereby, enabling the user to determine the relevant entities and products for the user's selected one or more claims of the patent.

As illustrated in FIG. 1a, the plurality of pre-trained large language model (LLM) units 106a-106e are key components of the system 100. The LLM units 106a-106e take the extracted claims as input and processes and analyzes these claims to strategically divide them into distinct claimed features or claimed elements or fundamental parts. Further, the LLM units 106a-106e deep dive into the information pool in search for relevant keywords, features and terminologies using deep learning models. The LLM units 106a-106e interact with its inbuilt database through predefined optimized prompts relevant to the specific claim elements to accurately identify top companies, startups, and products related to the patent.

Further, the background collection module 110 is configured to perform an internet-based search utilizing the predefined optimized prompts to generate highly accurate search topics, enabling the retrieval of a relevant pool of hyperlinks. Specifically, the background collection module 110 comprises a first LLM unit 106a, which strategically processes and analyzes the extracted claims by dividing them into distinct claim elements; the advanced searching unit 108, which conducts targeted internet searches based on these optimized prompts to gather relevant hyperlinks; and a third LLM unit 106c, which filters and refines the retrieved hyperlinks based on defined relevancy parameters to ensure accuracy and usefulness of the search results.

The first LLM unit 106a is configured to effectively process and analyze the extracted claims, strategically dividing them into distinct claim elements. The advanced searching unit 108 performs an optimized internet-based search to identify companies, startups, and products relevant to the received input. Further, the advanced searching unit 108 operates in conjunction with the pre-trained third LLM unit 106c, which sorts and filters the pool of hyperlinks based on specific parameters such as publication dates, availability of web-scrapable content, and verification against “404 Not Found” errors. This targeted filtering results in a refined set of relevant hyperlinks, which, when further processed by the third LLM unit 106c, facilitates accurate identification of pertinent companies, startups, and products from multiple sources. Consequently, this combined process forms a second list of results.

The background collection module 110 ensures the inclusion of the most up-to-date and pertinent information during the analysis. In some embodiments, the system 100 is configured to allow the user to divide the extracted claims into distinct claim elements, in any desired manner at the first LLM unit 106a. Thereby facilitating the user with the flexibility to customize the distinct claim elements from the extracted claims according to their discretion, for further processing in the system 100.

The second pre-trained large language model (LLM) unit 106b performs analysis by leveraging optimized prompts. The LLM unit 106b extracts pertinent data from the inbuilt database to generate a first list of results. The LLM unit 106b is configured to perform analysis based on relevancy to the specific claim elements. As a result, the system 100 can accurately identify top companies, startups, and products related to the patent.

Further, the result combiner unit 112, is configured to provide a final list of the relevant entities and products. The fourth LLM unit 106d combines the first list of results obtained from the second LLM unit 106b and the second list of results obtained from the background collection module 110, to generate a final list that includes claim elements, a comprehensive selection of top relevant companies, startups, and leading products launched either before or after the priority date of the patent number received as the input.

In another embodiment of the present disclosure, the system 100 is configured to provide users with multiple options for specifying inputs related to target entities or products. Specifically, the system 100 allows users to: (a) select or manually input one or more target companies or startups; (b) directly upload relevant product information, such as product brochures or data sheets; and (c) upload a set of product-specific hyperlinks. The flexibility in input methods enables the system 100 to further process and analyze patent data by incorporating human-curated evidence and supervisory input, thereby enhancing the accuracy, reliability, and relevance of the generated results.

Furthermore, the web mining unit 114 is configured to search the internet for the relevant hyperlinks corresponding to web pages disclosing features associated with claim elements of the identified products. In addition, the web mining unit 114 is equipped with advanced filtering capabilities, enabling it to refine the selection of hyperlinks based on the parameters such as publication dates, content relevance, accessibility of web-scrapable content, and verification to avoid invalid or broken links (e.g., “404 Not Found” errors). After this rigorous filtering process, the web mining unit 114 extracts textual content from the selected hyperlinks and saves this information as background text, thus ensuring the collection of accurate, reliable, and contextually relevant data. The web mining unit 114 further extracts text from the selected hyperlinks and save the background text. This extracted background text helps to enrich the knowledge used by the RAG module 116, enhancing the accuracy and relevance of the claim elements mapping process. At the same time the extracted background text is added to the background collection module 110 to update the information.

The retrieval augmented generation (RAG) module 116 is configured to work in conjunction with the fifth LLM unit 106e. The RAG module 116 comprises an embedding unit 116a and a vector database unit 116b. The embedding unit 116a is configured to process and embed the background text extracted from the identified hyperlinks of the products, effectively representing the context and semantics of the information for enhanced understanding and analysis of the claim elements. The vector database unit 116b is configured for creating a vector database based on contextual compression indexing techniques for efficient storage and retrieval of relevant information.

The claim chart generator module 118 is configured to work in conjunction with the RAG module 116 and leverages the LLM unit 106e to generate claim chart tables for each identified product against the claim elements. The claim chart generator module 118 further provides a comprehensive contextual mapping of each of the claim elements to the corresponding products, facilitating a clear and organized representation of the relationship between claim elements and identified products in the patent analysis.

Moreover, the ranking module 119 is configured to rank multiple patents by overlapping features with infringing products based on a weighted-average score. Further, the ranking module 119 is configured as an intelligent ranking layer integrated into the report generation workflow. Specifically, the ranking module 119 receives detailed claim-feature mappings generated by the claim chart generator module 118 and systematically analyzes these mappings by applying quantitative, weightage-based scoring methods and calculating mapping percentages. As a result, the ranking module 119 generates a prioritized, sorted list of patents and products. This prioritization ensures that the highest-ranked results are contextually and semantically significant, not merely those matching superficial keyword similarities. Consequently, the ranking module 119 provides users with focused insights by highlighting the most relevant patents overlapping with product features, thereby streamlining the analysis and decision-making process related to comprehensive patent portfolio management.

Further, the report generation unit 120 is configured to generate a summarized report 400 (as shown in FIG. 4) for all identified products, giving comprehensive detailing about each product against the specific claim elements of the received patent. The report generation unit 120 involves repeating the process for all the identified products to generate a final report with a detailed, clear, and organized representation of the relationship between claim elements and identified products. The generated report is sent to the user through registered email, along with a system notification. The generated report provided to the user can be in any file format known in the art, non-limiting examples of which are xlsx, xml, .txt and the like. Thereby, providing an efficient, accurate, and comprehensive solution for patent analysis and the identification of relevant entities and products in a particular technology domain.

In another embodiment, the report generation unit 120 is configured to generate a combined summarized report 400 for all identified products, giving comprehensive detailing about each product against the specific claim elements of the received two or more patents. The combined summarized report 400 can be provided to the user in any file formats known in the art, non-limiting examples of which are .xlsx, .xml, .txt and the like. The summarized report 400 comprises an image report and a textual report. Further, the report generation unit 120 is configured to provide ranking of the received one or more patents using the inputs from the ranking module 119. The ranking serves as a benchmark of excellence, highlighting products that exhibit optimal alignment with the one or more claims of the received one or more patents and demonstrates an exceptional standard of compliance with predefined criteria.

In an embodiment of the present disclosure, the system 100 is configured to provide an alert notification feature integrated with scheduled processing. The user provides inputs through an input unit 102, specifying patent identifiers along with one or more target companies and defining alert-time preferences for notifications. After receiving these inputs, the system 100 performs patent information extraction through unit 104 and proceeds sequentially through modules including the background collection module 110 comprising the first LLM unit 106a, the advanced searching module unit 108, and the third LLM unit 106c, followed by the result combiner unit 112, the web mining unit 114, the retrieval augmented generation (RAG) module 116, the claim chart generator module 118, the ranking module 119, and the report generation unit 120. Upon completion of the processing, a scheduler unit 121 initiates the predefined alert notifications based on the user-defined preferences. The scheduler unit 121 is configured to send timely notifications or alerts, informing the user about the completion of analysis and the availability of processed reports, thereby enhancing user convenience and operational efficiency.

Further, the system 100 is configured to maintain logs of data processed at one or more of the input unit 102, the patent information extraction unit 104, the large language model (LLM) units 106a-106e, the advanced searching unit 108, the background collection module 110, the result combiner unit 112, the web mining unit 114, the retrieval augmented generation (RAG) module 116, the claim chart generator module 118, the ranking module 119, the report generation unit 120, and the scheduler unit 121, of the system 100, during the operation. The user can access the logs through the user interface unit of the system 100.

Furthermore, the system 100 is configured to provide an interactive chatbot function designed to enhance user engagement during the operation of the system 100. The chatbot offers a dialogue-based interaction, allowing users to either discuss the collective attributes and performance data of all identified products or to conduct an in-depth interrogation of specific details and technical specifications of one of the identified products. By way of example, but not limitation, the chatbot can be accessible from the system's history page, where users can choose their desired level of product detail interaction. Further, the chatbot is configured to generate responses by referencing hyperlinks from the report or by conducting real-time web searches to fetch the most current product-specific information, thus providing a versatile and detailed analysis tool for users to make informed decisions based on comprehensive data.

FIG. 1b illustrates another exemplary block diagram of the system 100 for determining relevant entities and products using LLM model in accordance with the present disclosure. This is a simplified arrangement corresponding to the system 100 previously depicted and discussed in FIG. 1a. The components previously discussed in detail in FIG. 1a and unchanged in functionality are intentionally omitted in FIG. 1b to avoid redundancy, enhance clarity and better represent the optimized configuration of the invention. Accordingly, FIG. 1b depicts a preferred embodiment configured to yield more precise and effective results. For the sake of brevity, elements and steps previously described in detail with respect to FIG. 1a are not repeated here. This simplified representation is provided to clearly emphasize modifications or alternate embodiments of the invention without redundancy. As can be seen here, the patent information extraction unit 104 is coupled only to the background collection module 110 at the output to provide the patent information 500, such as title, abstract, claims, etc., to the background collection module 110. The background collection module 110 is configured to extract the claims, where the first LLM unit 106a strategically divides the claims into the distinct claim elements. The advanced searching unit 108 performs targeted internet searches using the optimized prompts, gathering the relevant hyperlinks. These hyperlinks are further refined by the LLM unit 106c based on predefined filtering parameters to ensure accuracy and contextual relevance. Further, the background collection module 110 is configured to provide its output to the result combiner unit 112 for consolidating the refined results for generating a cohesive set of relevant data. The system 100 of FIG. 1b excluded the LLM units 106b, 106d, thereby providing a more accurate output with the simplified arrangement. Furthermore, FIG. 1b provides a direct connection between the background collection module 110 and the result combiner unit 112.

FIG. 2a and FIG. 2b illustrate an exemplary flow chart for a method 200 for determining the relevant entities and products using the LLM model in accordance with the present disclosure. The method 200 is configured to be performed on the system 100. The system 100 comprises the input unit 102, the patent information extraction unit 104, the plurality of LLM units 106a-106e, the advanced searching unit 108, the background collection module 110, the result combiner unit 112, the web mining unit 114, the RAG module 116, the claim chart generator module 118, the ranking module 119, the report generation unit 120, and the scheduler unit 121. The method 200 comprises the following steps:

In step 202, the method 200 comprises creating the user account by accepting valid email ID. To validate the user account, the user specific information such as phone number, password, valid email ID etc. is required. The valid Email id is used for receiving the summarized report 400 (as shown in FIG. 4).

In step 204, the method 200 comprises receiving the number associated with the patent as the input from the user. Further, the number associated with the patent may be selected from any one of the patent application number, the patent publication number, and equivalents thereof.

In step 206, the method 200 comprises extracting, using the patent information extraction unit 104, information such as title, abstract, claims, detailed description, inventors, assignee, and priority date, related to the received patent number from more than one patent databases like Google patent, Espacenet, Wipo and other paid databases.

In an embodiment of the present disclosure, the patent information extraction unit 104 is coupled to the backend server 101 selected from the group comprising cloud servers, locally managed servers, third-party services, or a combination thereof.

In step 208, the method 200 comprises processing and analyzing, extracted claims using the plurality of LLM units to provide distinct claim elements. The plurality of LLM units comprising the first LLM unit 106a, the second LLM unit 106b, the third LLM unit 106c, the fourth LLM unit 106d, and the fifth LLM unit 106e.

In step 210, the method 200 comprises performing, by an advanced searching unit 108, an internet-based search to identify relevant entities and products based on the distinct claim elements. In an embodiment, the method 200 further comprises processing and analyzing the extracted claims using the first LLM unit 106a, conducting, by the advanced searching unit 108, targeted internet searches based on the optimized prompts to gather the relevant hyperlinks and filtering and refining the retrieved hyperlinks based on predefined relevancy parameters using the third LLM unit.

In another embodiment, the method 200 comprises performing, using the background collection module 110, the internet-based search utilizing predefined optimized prompts to generate search topics for retrieving the relevant hyperlinks.

In step 212, the method 200 comprises generating, using the result combiner unit 112, the first list of results obtained from both the LLM 106b and the second list of results obtained from the background collection module 110, to generate a final list via the LLM 106d.

In an embodiment of the present disclosure, the method 200 comprises interacting, using the plurality of LLM units, with the inbuilt database through predefined optimized prompts specific to the distinct claim elements.

In step 214, the method 200 comprises searching, using the web mining unit 114, for relevant hyperlinks disclosing features associated with claim elements of the identified relevant entities and products. In an embodiment, the method 200 step of searching for the relevant hyperlinks further comprises filtering the relevant hyperlinks based on the one or more parameters including the publication dates, content relevance, accessibility of web-scrapable content, and verification to avoid invalid or broken links.

In step 216, the method 200 comprises processing and embedding, using the Retrieval Augmented Generation (RAG) module 116, the background text extracted from the relevant hyperlinks of the identified entities and products to represent the context and semantics of the information. In an embodiment, the step of processing and embedding the background text by the RAG module 116 comprises processing and embedding, by the embedding unit 116a, the background text extracted from the relevant hyperlinks of the identified entities and products. The method 200 step further comprises creating the vector database, the vector database unit 116b, based on the contextual compression techniques for storing and retrieving the background text.

In step 218, the method 200 comprises generating using the claim chart generator module 118, a claim chart table for each of the identified entities and products against the distinct claim elements.

In step 220, the method 200 comprises ranking, using a ranking module 119, the patent via applying the quantitative weightage-based score and calculating a mapping percentage to generate a prioritized, sorted list of patents and products. The weightage-based score is obtained via overlapping features of the patent with the identified entities and products.

In an embodiment of the present disclosure, the method 200 further comprising providing by the ranking module 119 the dashboard 300 (as shown in FIG. 3) that integrates the specialized interactive component comprising the first para-agent 302, and the second para-agent 304. The first para-agent 302 is configured for analyzing the claims of the patent based on images of the identified entities and products. Further, the second para-agent 304 is configured to modify and refine the claims based on the unclaimed subject matter derived from specification of the patent using the second para-agent 304. Furthermore, the unclaimed subject matter is identified by the second para-agent 304 via analyzing the specification of the patent and the corresponding claim mapping with the product.

In step 222, the method 200 comprises generating using the report generation unit 120, a summarized report 400 for all the identified entities and products, thereby providing comprehensive details about each of the entities and products against the specific claim elements of the received patent. Further, the summarized report 400 comprises an image report and a textual report.

In an embodiment of the present disclosure, the method 200 comprises initiating the predefined alert notifications, using the scheduler unit 121, based on the user-defined preferences for informing the users regarding the completion of analysis and generation of summarized reports 400.

FIG. 3 illustrates an exemplary dashboard 300 interface provided by the ranking module 119 in accordance with the present disclosure. The dashboard 300 is configured to visually present ranked patent analysis data processed by the system 100. The dashboard 300 interface includes columns indicating patent rankings, the patent numbers, descriptive titles, claim details, associated entities and products, claim mapping summaries, and the weighted average scores. Further, the dashboard 300 integrates interactive Para Agents offering image-based visual analysis of claim-to-product mappings, thereby enabling the user refinement of the patent claims by identifying unclaimed or incompletely claimed technical subject matter. The dashboard 300 thus facilitates efficient, intuitive, and comprehensive patent data evaluation for users.

In another embodiment of the present disclosure, the ranking module 119 further comprises a user-interactive dashboard 300 configured to enable users to intuitively explore, analyze, and interact with patent information 500 (as shown in FIG. 5) processed by the system 100. The dashboard 300 provided by ranking module 119 comprises multiple columns, each specifically designed to represent critical patent-related data. A first column displays the ranked position for each analyzed patent reference, determined by contextual and quantitative analysis performed within the system 100, such that entries positioned higher on the dashboard 300 represent greater relevance. A second column is configured to display the patent numbers corresponding to each respective entry, allowing for an accurate patent identification. A third column comprises brief descriptive titles that clearly indicate the subject matter or primary technical area of each patent, enabling quick comprehension by the user.

Additionally, the dashboard 300 further comprises a fourth column displaying a claim number that specifies the particular claim within the patent undergoing analysis, facilitating the identification of the exact claim involved in the mapping process. Another column identifies the company associated with each patent or product, thereby providing immediate insight into potential competitors or relevant entities in the market. Correspondingly, a separate column discloses the specific product associated with each listed patent, allowing users to directly cross-reference patents with commercially available implementations or disclosed products.

Moreover, the dashboard 300 includes a column displaying the total count of distinct claim elements extracted and analyzed for each patent or prior-art entry. Another column provides a visual mapping summary that succinctly indicates the mapping relationship between individual claim elements and associated products, thus enabling users to efficiently interpret and assess the claim-product relevancy at a glance. Further, the dashboard 300 comprises the weighted average score column, quantitatively representing the strength and precision of the mapping between the patent claim elements and the respective products, where higher scores indicate stronger and more precise correlations.

In a further aspect of the present disclosure, the dashboard 300 integrates a specialized interactive component referred to herein as a Para Agent, comprising two distinct functional features, namely, a first para-agent 302 and a second para-agent 304. The first Para Agent 302 involves image-based claim analysis. The agent enables a user to visually assess how product images correspond to and overlap with the claim elements of a selected patent. This feature provides a graphical and intuitive analysis, facilitating enhanced comprehension of the visual alignment between patent claims and products. The second Para Agent 304 permits users to modify or refine claims from previously analyzed patent applications within system 100. Specifically, the second agent feature, referred to herein as the unclaimed subject matter agent, is configured to analyze patent descriptions and claim mapping outputs to identify the key technical features described within the patent specification but not explicitly claimed. Utilizing an inference-based analytical approach, the second para agent 304 detects technical elements that remain unclaimed, inadequately claimed, or implicitly disclosed without explicit coverage in existing claims. Upon identifying such unclaimed or insufficiently claimed features, the agent 304 generates suggestions for refined or additional claim language aimed at enhancing protection of valuable but previously overlooked aspects of the invention.

Furthermore, the dashboard 300 interface provides a column for executing various user actions, such as accessing detailed analysis reports, appending user notes or comments, initiating further processing, or excluding selected entries from the analysis set. An additional column indicates the current report-generation status, informing the user whether detailed analytical reports have been completed or remain pending for individual patents or products. Additionally, a user notes column is configured to enable users to store personalized annotations or comments related to each patent entry, thereby maintaining an organized and customized analysis record. Finally, the dashboard 300 includes a timestamp column indicating the precise date and time at which each individual entry was processed or updated, providing transparency regarding the currency and timeliness of the displayed patent data.

Thus, the ranking module 119 and its associated interactive dashboard 300 significantly enhance user engagement and analytical efficiency by combining advanced AI-based patent analysis, intelligent interactive agents, and structured visual data presentation into a single cohesive interface, thereby improving decision-making capabilities in intellectual property management, competitive analysis, and related fields.

In some embodiments, the system 100 is designed to rerun the operation previously executed for the one or more patents, utilizing the logs of the data stored from the last operation. The utilization of the logs of the data enables the system 100, to receive and incorporate the new inputs, for example, but not limited to, a new target company, efficiently process only the necessary data. It leverages the existing data from the logs to provide relevant entities and products for the new target company associated with the received patents and products only for the new target company, for the received one or more patents, using the system 100.

FIG. 4 illustrates an exemplary user interface displaying the summarized report 400 generated by the report generation module including potential target company and product mapping in accordance with the present disclosure. The summarized report 400 comprises the distinct claim elements that are mapped to the technical features of the product ABC of the company ABC. The tick symbol indicates that the claim element is perfectly matched with the specific feature of the product ABC. Further, the symbol of I denotes that the claim elements are not matched completely with the product feature. The symbol I indicates inferential mapping of the claim element.

FIG. 5 illustrates another exemplary user interface displaying the extracted patent information 500 for the patent, generated by the patent information extraction unit 104 via enhanced analysis of patent data using the LLM model in accordance with the present disclosure. Further, the patent information extraction unit 104 is configured to fetch the details of the patent using the patent number U.S. Ser. No. 12/315,605B1, fetched from the one or more databases. The details include the patent application number, the publication number, the priority number, the title, the publication date, an application date, a priority date, an assignee, an inventor, abstract and independent claims. This is the sample format of the summarized report 400, for an exemplary patent number.

The present invention offers significant advantages over prior art systems for patent analysis and product identification. By leveraging advanced artificial intelligence techniques, including robust large language models (LLM) and retrieval augmented generation (RAG) module 116, the system 100 provides highly accurate and contextually relevant results. The integration of internet-based searching, web mining, and claim chart generation capabilities allows for a comprehensive analysis that goes beyond traditional keyword-based approaches. The system's ability to generate both image and textual reports provides a rich, multi-faceted analysis of patents and related products, offering visual representations of product features mapped to claim elements alongside detailed written analysis. This dual reporting approach, combined with detailed comparative analysis, provides greater insights for market and trend analysis, facilitating implicit identification of product patentability and potential whitespaces in various fields. The invention's wide applicability across industries makes it valuable for intellectual property management, patent litigation, licensing, technology scouting, competitor analysis, patentability evaluation, and investment assessments. By streamlining the complex process of patent analysis and product identification, this system 100 offers a more efficient, accurate, and comprehensive solution that significantly enhances an organization's intellectual property strategy and competitive positioning.

Although the present disclosure has been described in terms of certain preferred embodiments, various features of separate embodiments can be combined to form additional embodiments not expressly described. Moreover, other embodiments apparent to those of ordinary skill in the art after reading this disclosure are also within the scope of this disclosure. Furthermore, not all of the features, aspects and advantages are necessarily required to practice the present disclosure. Thus, while the above detailed description has shown, described, and pointed out novel features of the disclosure as applied to various embodiments, it will be understood that various omissions, substitutions, and changes in the form and details of the apparatus or process illustrated may be made by those of ordinary skill in the technology without departing from the spirit of the disclosure. The disclosures may be embodied in other specific forms not explicitly described herein. The embodiments described above are to be considered in all respects as illustrative only and not restrictive in any manner.

What is claimed is:

1. A system for determining relevant entities and products, the system comprising:
a patent information extraction unit configured to extract patent information associated with a received patent number of a patent from one or more patent databases;
a plurality of large language model (LLM) units configured to process and analyze extracted claims to provide distinct claim elements;
an advanced searching unit configured to perform an internet-based search to identify relevant entities and products based on the distinct claim elements;
a result combiner unit configured to generate a list of relevant entities and products;
a web mining unit configured to search for relevant hyperlinks disclosing features associated with the claim elements of the relevant entities and products;
a retrieval augmented generation (RAG) module configured to process and embed background text extracted from the relevant hyperlinks of the identified entities and products;
a claim chart generator module configured to generate claim chart tables for each of the identified entities and products against the distinct claim elements;
a ranking module configured to rank the patent via applying a quantitative weightage-based score and calculating a mapping percentage to generate a prioritized, sorted list of patents and products, the weightage-based score is obtained via overlapping features of the patent with the identified entities and products; and
a report generation unit configured to generate a summarized report for the identified entities and products, providing comprehensive details about each of the entities and products against the specific claim elements of the received patent, wherein the summarized report comprises an image report and a textual report.

2. The system of claim 1, wherein the patent information extraction unit is coupled to a backend server selected from a group comprising cloud servers, locally managed servers, third-party services, or a combination thereof.

3. The system of claim 1, wherein the plurality of LLM units comprising a first LLM unit, a second LLM unit, a third LLM unit, a fourth LLM unit and a fifth LLM unit, the plurality of LLM units are configured to interact with an inbuilt database through predefined optimized prompts specific to the distinct claim elements.

4. The system of claim 1, further comprising a background collection module configured to perform an internet-based search utilizing predefined optimized prompts to generate search topics for retrieving relevant hyperlinks.

5. The system of claim 4, wherein the background collection module comprises:
a first LLM unit configured to process and analyze the extracted claims;
the advanced searching unit configured to conduct targeted internet searches based on the optimized prompts to gather the relevant hyperlinks; and
a third LLM unit configured to filter and refine the retrieved hyperlinks based on predefined relevancy parameters.

6. The system of claim 1, wherein the web mining unit is configured to filter the relevant hyperlinks based on one or more parameters including publication dates, content relevance, accessibility of web-scrapable content, and verification to avoid invalid or broken links.

7. The system of claim 1, wherein the RAG module comprises:
an embedding unit configured to process and embed the background text extracted from the relevant hyperlinks of the identified entities and products; and
a vector database unit configured to create a vector database based on contextual compression indexing techniques for storing and retrieving the background text.

8. The system of claim 1, further comprising a scheduler unit configured to initiate predefined alert notifications based on user-defined preferences for informing users regarding completion of analysis and generation of summarized reports.

9. The system of claim 1, wherein the ranking module is configured to provide a dashboard that integrates a specialized interactive component comprising a first para-agent and a second para-agent, wherein the first para-agent is configured to analyze the claims of the patent based on images of the identified entities and products.

10. The system of claim 9, wherein the second para-agent is configured to modify and refine the claims based on an unclaimed subject matter derived from specification of the patent, the unclaimed subject matter is identified by the second para-agent via analyzing the specification of the patent and the corresponding claim mapping with the product.

11. A method for determining relevant entities and products, comprising:
extracting, using a patent information extraction unit, patent information associated with a received patent number of a patent from one or more patent databases;
processing and analyzing, extracted claims using a plurality of large language model (LLM) units to provide distinct claim elements;
performing, using an advanced searching unit, an internet-based search to identify relevant entities and products based on the distinct claim elements;
generating, using a result combiner unit, a list of the relevant entities and products;
searching, using a web mining unit, for relevant hyperlinks disclosing features associated with the claim elements of the relevant entities and products;
processing and embedding, using a retrieval augmented generation (RAG) module, a background text extracted from the relevant hyperlinks of the identified entities and products;
generating, using a claim chart generator module, claim chart tables for each of the identified entities and products against the distinct claim elements;
ranking, using a ranking module, the patent via applying a quantitative weightage-based score and calculating a mapping percentage to generate a prioritized, sorted list of patents and products, wherein the weightage-based score is obtained via overlapping features of the patent with the identified entities and products; and
generating a summarized report, using a report generation unit, for the identified entities and products, providing comprehensive details about each of the entities and products against the specific claim elements of the received patent, wherein the summarized report comprises an image-report and a textual report.

12. The method of claim 11, wherein the patent information extraction unit is coupled to a backend server selected from a group comprising cloud servers, locally managed servers, third-party services, or a combination thereof.

13. The method of claim 11, further comprising interacting, using the plurality of LLM units, with an inbuilt database through predefined optimized prompts specific to the distinct claim elements, wherein the plurality of LLM units comprising a first LLM unit, a second LLM unit, a third LLM unit, a fourth LLM unit and a fifth LLM unit.

14. The method of claim 11, further comprising performing, using a background collection module, an internet-based search utilizing predefined optimized prompts to generate search topics for retrieving the relevant hyperlinks.

15. The method of claim 14, further comprises a background collection module for performing the internet-based search comprising:
processing and analyzing the extracted claims using a first LLM unit;
conducting, by the advanced searching unit, targeted internet searches based on the optimized prompts to gather the relevant hyperlinks; and
filtering and refining the retrieved hyperlinks based on predefined relevancy parameters using a third LLM unit.

16. The method of claim 11, wherein the step of searching for relevant hyperlinks comprises filtering the relevant hyperlinks based on one or more parameters including publication dates, content relevance, accessibility of web-scrapable content, and verification to avoid invalid or broken links.

17. The method of claim 11, wherein processing and embedding background text by the RAG module comprises:
processing and embedding, by an embedding unit, the background text extracted from the relevant hyperlinks of the identified entities and products; and
creating a vector database, by a vector database unit, based on contextual compression indexing techniques for storing and retrieving the background text.

18. The method of claim 11, further comprising initiating predefined alert notifications, by a scheduler unit, based on user-defined preferences for informing users regarding completion of analysis and generation of summarized reports.

19. The method of claim 11, further comprising providing a dashboard that integrates a specialized interactive component comprising a first para-agent, and a second para-agent, wherein the first para-agent is configured for analyzing the claims of the patent based on images of the identified entities and products.

20. The method of claim 19, wherein the method further comprising modifying and refining the claims based on an unclaimed subject matter derived from specification of the patent using the second para-agent, wherein the unclaimed subject matter is identified by the second para-agent via analyzing the specification of the patent and the corresponding claim mapping with the product.
